(19) United States
(12) Patent Application Publication
(10) Pub. No.: US 2004/0172398 A1
(43) Pub. Date: Sep. 2, 2004

(54) Method, databank system and computer program product for designing a technical facility

(76) Inventors: Klaus Albert, Erlangen (DE); Ewald Herrmann, Mohrendorf (DE); Andreas Wiblishauser, Wiesenthau (DE)

Correspondence Address: STAAS & HALSEY LLP, SUITE 700, 1201 NEW YORK AVENUE, N.W., WASHINGTON, DC, 20005, US

(21) Appl. No.: 10/474,374

(22) PCT Filed: Mar. 28, 2002
(86) PCT No.: PCT/DE02/01170

(30) Foreign Application Priority Data
Apr. 9, 2001 (DE) 101 17 645.7

(51) Int. Cl. G06F 7/00

(52) U.S. Cl. 707/100

(57) ABSTRACT

Using the specification of facility components and modifications thereof stored in a file, working data stock is marked as current reference data stock upon a first request by the user. The working data stock is automatically compared with the current reference data stock by a retrievable comparison. Modifications are identified and the working data stock is then marked as new reference data stock upon a second request by the user. A novel data bank system is used in carrying out the method by a computer program.

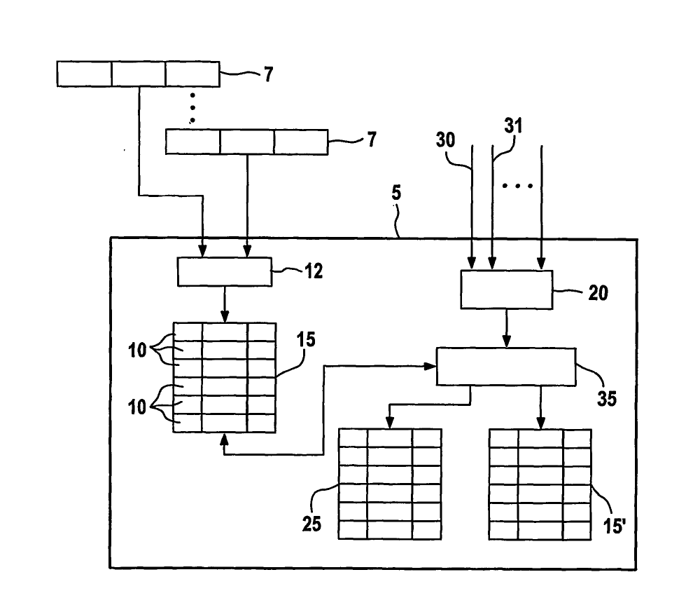

Today, modern technical installations normally have a large number of single functions whose interplay determines the overall function of the technical installation.

In this context, the single functions normally need to be provided by installation components which interact with one another, for example by exchanging materials and/or information.

An important aspect of configuring a technical installation is the selection of suitable installation components for providing the single functions, so that the interaction of the installation components also provides the desired overall function of the technical installation. Normally, a plurality of changes, particularly in relation to the installation components used, arise during the configuration phase because installation components which have already been selected have turned out to be unsuitable or because additional single functions need to be provided.

If the technical installation is a power plant, for example, then it is necessary to configure at least the measurement stations—at which data are produced during subsequent operation—, the consumers of all types of energy, particularly electrical energy, the fittings for controlling and/or connecting the installation components, and the line systems—for example a pipeline system.

To this end, an engineer who has been given this task normally creates a respective list into which he enters the components provided for use in the installation together with information, for example with which function the component is associated, at which location it is installed, from where it is fed, where it feeds, what connection load it has etc.

If changes are now made, then the configuring engineer needs to ensure that he keeps his configuration list up to date at all times. To this end, he needs to mark the list at least whenever a change has been made, for example by entering the last change date. If there are a plurality of configuration lists in circulation—which is normally the case with the configuration teams often formed today—, then he needs to set up a change service and to ensure that all configuration lists in circulation are updated after a change. Otherwise, problems can arise because it is not possible to tell whether or not a list which is currently available now reflects the current configuration state of the installation.

There is a major source of error here. By way of example, the following can happen: on account of a configuration list not being up to date, a team member selects another component for the installation, enters it in his list—in some cases even forgets to notify the other team members of his change—, orders the component and installs it in the installation. Design errors can now result in the new component not matching the ones which are already present or even resulting in a hazard for humans and material during operation; there is thus a loss, at least as far as the configuration involvement is concerned, since errors need to be recognized and reversed, or even in terms of humans (for example if an incorrectly designed component becomes unstable and explodes) and material (overloading, excessive wear, destruction).

In addition, it is barely possible to tell what changes have been made during the configuration.

To improve the situation described above, it is known practice for the configuration lists to be processed electronically by inputting the configuration data into a database to which all team members have access.

This allows the lists to be kept up to date at least, since all the team members access just one data stock and make changes only there.

However, it is also not possible to tell what changes have been made during the configuration phase; in particular, it is not possible to tell whether currently available data are showing just one “intermediate state” which is (still) not suitable for the implementation, or whether these data already reflect a valid state. In addition, changes can be tracked only by means of a manual comparison with data which were stored before the change.

The invention is therefore based on the object of specifying a method, a database system and a computer program product for configuring a technical installation which overcome the drawbacks described above, improve the configuration and can be used flexibly.

For the method, the invention achieves the object by means of a method for configuring a technical installation having a number of installation components using the following steps:

1. A specification for each installation component is respectively stored as a data record in an electronic database, and the data records are used to form a working data stock.

2. During the configuration, specification changes to one or more installation components in the database are transferred to the working data stock.

3. The working data stock is identified as the current reference data stock.

4. The working data stock in the database is provided for a retrievable automatic comparison with the current reference data stock, and retrieval of the comparison prompts identification of those data in the working data stock which are different in relation to the current reference data stock, and

5. a second user request prompts the working data stock to be identified as the new current reference data stock.

The inventive method makes it possible to tell what changes have been made in the course of configuration by virtue of a current data stock being marked as the reference data stock by a user request (for example if the current data stock is valid and describes a prototype for the installation, for example), changes made thereafter being stored together with the data records which are not affected by the change, this working data stock produced in this manner being compared with the reference data stock on the basis of another user request, and changes relating to the reference data stock being marked and possibly displayed and/or stored.

In this way, a configuring engineer has, at all times during configuration, an overview of what change has been made since a last valid data stock. He can then check the changes, for example specifically, to determine whether they are suitable for the purpose of attaining a desired success and/or for the purpose of providing a new function and/or for the purpose of intentionally removing an originally planned function etc. If they are, he can use a further user request to mark the changed data stock as the (new) current reference data stock.

This significantly reduces errors which arise very often in practice when configuring a technical installation.

Advantageously, all the working data stocks which respectively arise during configuration as a result of changes are stored.

In this way, the people involved in configuration can get an overview of all changes made during the configuration, even if these changes need not always have valid data stocks, e.g. if components were replaced as an experiment but the replacement was reversed again later. It is thus also possible to revert to changes which were discarded at first but which could be relevant again at a later time.

In another advantageous refinement of the invention, all the reference data stocks which arise during configuration are stored.

It is thus possible for the configuration personnel to obtain, at any time, an overview of what data stocks were ever valid at any time up to the current time, for example what data stocks in the form of lists a customer has been given in the course of the project. It is thus particularly easy to recognize what the changes were in detail in relation to a configuration file which was valid last, which means that project tracking is simplified considerably.

One advantage in this context is that the reference data stocks are respectively stored together with an explicit revision status marking.

The revision status marking is an explicit identification feature which allows the reference data stocks to be distinguished from one another, for example by providing the reference data stocks with a rising numerical index in their order over time.

In another advantageous refinement of the invention, the database is a computer with a database program, particularly Microsoft Access.

Commercially available database programs are particularly suitable for recording data, for example configuration data, easily and with little cost involvement, storing them and, by way of example, conditioning them for printing. The known database program Microsoft Access is distinguished, in particular, in that it is very widespread, can run on almost any computer, and a broad group of people are already familiar with its use. In addition, this database program makes database queries, which are used to filter specific data components from the total data stock, particularly easy to implement.

Advantageously, a working data stock is compared with a reference data stock using at least one automatically executable database query, particularly one produced using the programming language SQL.

Database queries can be used—as already mentioned—to retrieve specific data components from the database. If a query criterion is now set up such that, by way of example, it can be used to detect data changes, then it is a simple matter to implement a comparison between data stocks. The known programming language SQL provides the required auxiliary means for generating a database query in a standardized form.

The invention also results in a database system for configuring technical installation having a number of installation components, where

a) a specification for each installation component can be respectively stored as a data record in a file in a database system,

b) specification changes for one or more installation components can be stored in the file,

c) a first user request prompts storage of the file as the current reference file, and

d) the database system is capable, in response to a second user request, of automatically comparing the file with the current reference file and of identifying those data in the file which are different than the data in the current reference file.

Advantageously, all the reference files which arise during configuration are stored together with a respective explicit revision status marking.

In one advantageous refinement of the invention, the database system is a data processing installation with a database program, particularly Microsoft Access.

One advantage in this context is that the file is compared with the current reference file using an automatically executable database query, particularly one produced using the programming language SQL.

The invention also results in a computer program product which is stored on a storage medium and contains software code portions which control execution of the inventive method when the program has been loaded into a computer's internal memory and is running on the computer.

An exemplary embodiment of the invention is illustrated in more detail below. The figure shows a database system in accordance with the invention.

The figure schematically shows a database system 5 in accordance with the invention which is implemented in a data processing installation. The specifications 7 of installation components of a technical installation are recorded using an input mask 12 and are stored as data records 10 in a file 15.

Changes made to the specifications 7 for the installation components during the configuration of the technical installation are likewise recorded using the input mask 12 and stored as data records 10 in the file 15.

A user of the inventive database system 5 can now use user requests 30, 31, which he inputs into a processing module 20, to condition the data stock in the database system 5.

By way of example, the user can send a first user request 30 to the processing module 20 in order to store the file 10 as the current reference file 25. The processing module 20 transmits this request to a query module 35 which then produces a reference file 25 and stores it.

To establish whether a current data stock in the file 15 has been altered with respect to the reference data stock in the reference file 25, the user can use a second user request 31 to initiate an automatic comparison between the file 15 and the current reference file 25. To this end, he transmits the request 31 to the processing module 20, which in turn prompts the query module 35 to compare the file 15 with the current reference file 25 automatically and to identify those data in the file 15 which are different than the data in the current reference file 25.

By way of example, the query module 35 can store the result of the comparison between the file 15 and the file 25 in a file 15′, with the changes being highlighted, for example colored, in the file 15′. In this way, the file 15′ can be used particularly easily to generate a printout of the changes on paper, for example, so that the changes are particularly easy to see.

In addition, the user can use a user request 30 to store the current file 15 as the new current reference file 25 at any time during configuration.

Advantageously, the database system 5 can store all files 15 and/or files 25 and/or files 15′ produced in the course of configuration, so that it is particularly easy to tell the order over time and the respective scope of changes which have been made. It is particularly advantageous if a reference file 25 is assigned an explicit revision status marking whenever said reference file is produced.

1. A method for configuring a technical installation having a number of installation components using the following steps:
a) a specification (7) for each installation component is respectively stored as a data record (10) in an electronic database (5), and the data records are used to form a working data stock,
b) during the configuration, specification changes for one or more installation components in the database (5) are transferred to the working data stock (15),
c) a first user request (30) prompts the working data stock (15) to be identified as the current reference data stock (25),
d) the working data stock (15) in the database is reserved for a retrievable automatic comparison with the current reference data stock (25), and retrieval of the automatic comparison prompts identification of those data in the working data stock (15) which are different in relation to the current reference data stock (25), and
e) a second user request prompts the working data stock (15) to be identified as the new current reference data stock (25).

2. The method as claimed in claim 1, where all the working data stock (15) which respectively arise during configuration as a result of changes are stored.

3. The method as claimed in claim 1 or 2, where all the reference data stocks (25) which arise during configuration are stored.

4. The method as claimed in claim 3, where the reference data stocks (25) are respectively stored together with an explicit revision status marking.

5. The method as claimed in one of claims 1 to 4, where the database (5) is a computer with a database program, particularly Microsoft Access.

6. The method as claimed in claim 5, where a working data stock (15) is compared with a reference data stock (25) using at least one automatically executable database query, particularly one produced using the programming language SQL.

7. A database system (5) for configuring a technical installation having a number of installation components, characterized in that
a) a specification (7) for each installation component can be respectively stored as a data record (10) in a file (15) in a database system (5),
b) specification changes for one or more installation components can be stored in the file (10),
c) a first user request (30) prompts storage of the file (15) as the current reference file (25), and
d) the database system is capable, in response to a second user request (31), of automatically comparing the file (15) with the current reference file (25) and of identifying those data in the file (15) which are different than the data in the current reference file (25).

8. The database system as claimed in claim 7, characterized in that
all the reference files (25) which arise during configuration are stored together with a respective explicit revision status marking.

9. The database system as claimed in claim 7 or 8, characterized in that
the database system (5) is a data processing installation with a database program, particularly Microsoft Access.

10. The database system as claimed in claim 9, characterized in that
the file (15) is compared with the current reference file (25) using an automatically executable database query, particularly one produced using the processing language SQL.

11. A computer program product which is stored on a storage medium and contains software code portions which control execution of the method as claimed in one of claims 1 to 6 when the program has been loaded into a computer's internal memory and is running on the computer.
